(19) United States
(12) Patent Application Publication
(10) Pub. No.: US 2026/0142281 A1
(43) Pub. Date: May 21, 2026

(54) INTEGRATED METAL HYDROGEN-OXYGEN FUEL CELL SYSTEM BASED ON ALUMINUM-LITHIUM ALLOY

(71) Applicants: Hainan University, Haikou City (CN); Hainan Lvran clean energy Co. Ltd., Haikou City (CN); Xi'an Yuchi Tengnan Defense Equipment Research Institute Co. Ltd., Xi'an City (CN); Huadian Water Technology Co. Ltd., Beijing (CN)

(72) Inventors: Xuerong ZHENG, Haikou City (CN); Beijia CHEN, Haikou City (CN); Honggeng LIN, Haikou City (CN); Huanyang LIU, Xi'an City (CN); Beiyang CHEN, Beijing (CN); Jianghai GUO, Beijing (CN); Caiyun ZHAO, Haikou City (CN); Wenjie HUANG, Haikou City (CN); Shurong YE, Beijing (CN); Hongmin XUN, Beijing (CN); Yida DENG, Haikou City (CN); Junda LU, Haikou City (CN)

(73) Assignees: Hainan University, Haikou City (CN); Hainan Lvran clean energy Co. Ltd., Haikou City (CN); Xi'an Yuchi Tengnan Defense Equipment Research Institute Co. Ltd., Xi'an City (CN); Huadian Water Technology Co. Ltd., Beijing (CN)

(21) Appl. No.: 19/390,574

(22) Filed: Nov. 16, 2025

(30) Foreign Application Priority Data
Nov. 15, 2024 (CN) 2024116301873

(51) Int. Cl. H01M 12/06; H01M 4/40; H01M 4/46; H01M 8/065; H01M 16/00

(52) U.S. Cl. CPC H01M 12/06; H01M 4/405; H01M 4/463; H01M 8/065; H01M 16/003

(57) ABSTRACT

An integrated metal hydrogen-oxygen fuel cell system based on aluminum-lithium alloy is provided. By optimizing the element composition and surface morphology of the negative electrode of a metal-air cell, the working voltage of the cell is kept stable, and the hydrogen generation efficiency and stability are significantly improved. The 2195 aluminum-lithium alloy is selected as the negative electrode to enhance the electrochemical activity, and more reaction sites are exposed through the optimized morphology to ensure the continuous generation of hydrogen by side reactions, thus providing sufficient and stable fuel for hydrogen-oxygen fuel cells.

### CROSS-REFERENCE TO RELATED APPLICATIONS

This application claims priority to Chinese Patent Application No. 202411630187.3, filed on Nov. 15, 2024, the contents of which are hereby incorporated by reference in their entirety.

### TECHNICAL FIELD

The disclosure belongs to the field of high-energy power supply, and in particular to an integrated metal hydrogen-oxygen fuel cell system based on aluminum-lithium alloy.

### BACKGROUND

With the advancement of technology, the development and design of high-energy portable power sources and emergency power supplies for environmental and energy applications are of great significance. Metal-air cells are cells that convert the chemical energy of fuels into electrical energy, using metals as the fuel at the negative electrode and oxygen as the fuel at the positive electrode. The metal-air cell includes a metal negative electrode, an electrolyte of salt or alkaline aqueous solution and an oxygen positive electrode. Commonly used materials for the metal negative electrode include Mg, Al, Zn, Fe, Li, and their alloys, while typical catalytic materials for the positive electrode include Pt, MnO₂, and other active substances. The cell electrolyte is generally a strong alkaline aqueous solution such as KOH or NaOH. Hydrogen-oxygen fuel cells are cells that convert chemical energy into electrical energy using hydrogen and oxygen from the air as fuels. The hydrogen-oxygen fuel cell includes a hydrogen anode, a separator, and an oxygen cathode. Hydrogen and oxygen react on the electrodes in the presence of catalysts to form water via the electrolyte. A commonly used type of the hydrogen-oxygen fuel cell is the proton exchange membrane fuel cell. Such cells essentially function as energy conversion devices. These cells offer advantages such as high conversion efficiency, large capacity, high specific energy, a wide power range, and no need for recharging. The metal-air cells are characterized by high theoretical energy density, long shelf life, abundant raw materials, and high safety, making them suitable for a wide range of applications, including portable power sources and emergency power supplies. However, the practical application of alkaline aluminum-air cells is limited by the issue of hydrogen evolution side reactions at the negative electrode, which reduces metal utilization and single-cell output voltage, and restricts the practical application of metal-air cells.

To address the issue of hydrogen evolution side reactions caused by corrosion of the negative electrodes in metal-air cells, the following three approaches are currently employed.

(1) The metal negative electrodes are added with other elements such as Sn, In, and Zn to increase the hydrogen evolution overpotential and suppress the hydrogen evolution side reaction. At present, the highest reported efficiency of hydrogen evolution suppression via this alloying method is 76%, which remains insufficient to effectively resolve the hydrogen evolution problem.

(2) Corrosion inhibitors such as NaCl, ZnO, and CaO are added to the electrolyte. However, the introduction of such inhibitors reduces the electrolyte conductivity and significantly decreases the current density of the cells.

(3) Pure magnesium alloy or pure aluminum alloy is used as the negative electrodes in metal-air cells to enhance hydrogen evolution, and then the gas pipeline is used to connect to a hydrogen-oxygen fuel cell to absorb the side reaction product hydrogen of the negative electrodes of the metal-air cells, thereby forming a “dual fuel cell”. In this configuration, however, the hydrogen evolution from the negative electrodes of the pure magnesium or pure aluminum is excessively high, while the hydrogen absorption capacity of the coupled hydrogen-oxygen fuel cell is limited. As a result, the large amount of hydrogen generated from the side reactions leads to low hydrogen utilization efficiency and resource wastage. Moreover, the metal-air cells and the hydrogen-oxygen fuel cells are merely connected through simple gas pathways, essentially forming a composite of two independent cells. This arrangement also reduces the overall energy utilization efficiency, thereby hindering the development of high-energy cell systems.

In view of the above limitations, the present disclosure is proposed.

### SUMMARY

The technical problem to be solved by the present disclosure is to overcome the shortcomings of the prior art and provide an integrated metal hydrogen-oxygen fuel cell system based on aluminum-lithium alloy, thus solving the problems raised in the above background technology.

In order to solve the technical problems, the disclosure adopts the following technical scheme.

An integrated metal hydrogen-oxygen fuel cell system based on aluminum-lithium alloy, which is a combined power supply system formed by coupling a metal-air cell and a hydrogen-oxygen fuel cell, where the metal-air cell includes a metal-air cell positive electrode, an electrolyte cavity, a negative electrode tab, an air cell air outlet and an aluminum-lithium alloy negative electrode; the metal-air cell positive electrode is connected with the electrolyte cavity and is responsible for reacting with oxygen in the air, generating current and supporting continuous reaction of a cell; the electrolyte cavity is connected with the negative electrode tab, and electrolyte in the electrolyte cavity reacts with the aluminum-lithium alloy negative electrode and outputs current through the negative electrode tab; the air cell air outlet is arranged at a top of the metal-air cell and is used for discharging hydrogen generated by a side reaction of the aluminum-lithium alloy negative electrode and conveying the hydrogen to the hydrogen-oxygen fuel cell through a gas pipe.

Optionally, the aluminum-lithium alloy negative electrode is an alloy including four metal elements: Al, Mg, Cu and Li.

Optionally, the metal-air cell positive electrode is formed by sequentially stacking and pressing the waterproof breathable membrane, the nickel mesh, the waterproof breathable membrane and the catalytic membrane; the waterproof breathable membrane is formed by mixing and pressing PTFE and carbon black materials; where a content of PTFE is 30-50 wt %, and a thickness of the waterproof breathable membrane is 0.30 mm.

Optionally, when preparing the metal-air cell positive electrode, a membrane electrode with a thickness of 0.56 mm is obtained by stacking and rolling in an order of waterproof breathable membrane, nickel mesh, waterproof breathable membrane and catalytic membrane, and the membrane electrode is sintered at 300° C. in a muffle furnace for 1 hour to obtain a complete air positive electrode.

Optionally, the catalytic membrane is formed by mixing and pressing the PTFE, conductive carbon, activated carbon and manganese dioxide in proportion, where a content of the PTFE is 10-15 wt %, contents of the conductive carbon, the activated carbon and the manganese dioxide are each 20-30 wt % respectively, and a thickness of the nickel mesh is 0.3 mm.

Optionally, the hydrogen-oxygen fuel cell includes an anode plate and a cathode plate; the hydrogen-oxygen fuel cell is internally provided with a membrane electrode of the hydrogen-oxygen fuel cell; a hydrogen-oxygen fuel cell tab is arranged above the anode plate; an anode part of the anode plate is provided with an anode hydrogen inlet which is communicated with an air outlet of the metal-air cell and used for introducing hydrogen generated by the metal-air cell into an anode of the hydrogen-oxygen fuel cell for reaction.

Optionally, opposite sides of the anode plate and the cathode plate are coated with an anode catalyst and a cathode catalyst respectively; the catalyst loading of an anode catalytic layer and a cathode catalytic layer is 0.5 mg/cm² of Pt/C for the anode and 0.25 mg/cm² of Pt/C for a cathode, respectively.

Optionally, a proton exchange membrane is arranged inside a cell membrane electrode; one side of the anode plate is provided with the anode catalytic layer, and an other side of the anode plate is provided with a titanium mesh.

Optionally, circuits of the metal-air cell and the hydrogen-oxygen fuel cell are connected in series, parallel or series-parallel connection.

After adopting the above technical scheme, compared with the prior art, the disclosure has the following beneficial effects. Of course, it is not necessary for any product to achieve all the following advantages at the same time.

First, by optimizing the elemental composition and surface morphology of the negative electrode of the metal-air cell, the working voltage of the cell is kept stable, and the hydrogen generation efficiency and stability are significantly improved. The negative electrode of 2195 aluminum-lithium alloy is selected to enhance the electrochemical activity, and more reaction sites are exposed through the optimized morphology to ensure the continuous generation of hydrogen by side reactions, thus providing sufficient and stable fuel for hydrogen-oxygen fuel cells. By coupling the metal-air cell with the hydrogen-oxygen fuel cell, the system realizes the efficient recycling of hydrogen, avoids the problem of hydrogen waste in traditional cells, and further improves the energy efficiency and cell performance of the whole system.

Second, the integrated metal hydrogen-oxygen fuel cell system of the present disclosure is capable of effectively absorbing the hydrogen generated by the side reaction of the negative electrodes of the metal-air cells, and by efficiently transmitting the hydrogen to the hydrogen-oxygen fuel cell for secondary power generation, the utilization efficiency of the hydrogen is greatly improved, thereby improving the overall energy output of the system. This design avoids the potential safety hazard caused by hydrogen accumulation in the metal-air cell, and effectively reduces the explosion risk that may be caused by hydrogen accumulation. Meanwhile, the timely a bsorption of hydrogen makes the system run more stably, reduces the cell temperature and prolongs the service life of the equipment. This integrated structure is simple and compact in design, and each module is easy to combine, easy to carry and maintain, and is capable of flexibly adapting to the needs of different scenarios. The system is not only suitable for portable power supply, but also can provide stable standby power supply in case of emergency, which meets various power requirements and has broad application prospects and market potential.

The specific embodiments of the present disclosure will be described in further detail with reference to the accompanying drawings.

### BRIEF DESCRIPTION OF THE DRAWINGS

The attached drawings in the following description are only some embodiments, and other drawings can be obtained according to these drawings without creative work for ordinary people in the field. In the attached drawings:

FIG. 1A is an SEM image of an aluminum-lithium alloy negative electrode in the metal-air cell of the present disclosure.

FIG. 1B is an Al elemental analysis diagram of the aluminum-lithium alloy negative electrode in the metal-air cell of the present disclosure.

FIG. 1C is the O elemental analysis diagram of the aluminum-lithium alloy negative electrode in the metal-air cell according to the present disclosure.

FIG. 1D is the CU elemental analysis diagram of the aluminum-lithium alloy negative electrode in the metal-air cell of the present disclosure.

FIG. 1E is the Mg elemental analysis diagram of the aluminum-lithium alloy negative electrode in the metal-air cell of the present disclosure.

FIG. 2 is the schematic structural diagram of the integrated metal hydrogen-oxygen fuel cell system in the present disclosure.

FIG. 3A is a voltage discharge curve of the hydrogen-oxygen fuel cell in Embodiment 1 at a low current density.

FIG. 3B is a cell capacity discharge curve of the hydrogen-oxygen fuel cell in Embodiment 1 at a low current density.

FIG. 4A is a voltage curve of the cell capacity of the hydrogen-oxygen fuel cell in Embodiment 2 at a high current density.

FIG. 4B is a discharge curve of the cell capacity of the hydrogen-oxygen fuel cell in Embodiment 2 at a high current density.

It should be noted that these drawings and written descriptions are not intended to limit the conceptual scope of the disclosure in any way, but to explain the concept of the disclosure to those skilled in the art by referring to specific embodiments.

### DETAILED DESCRIPTION OF THE EMBODIMENTS

The present disclosure will now be described in further detail with reference to the attached drawings.

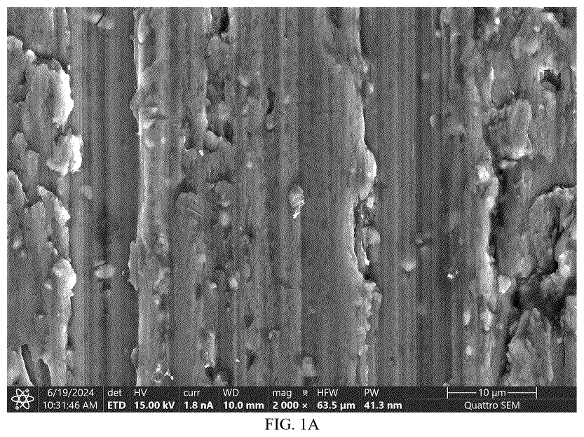

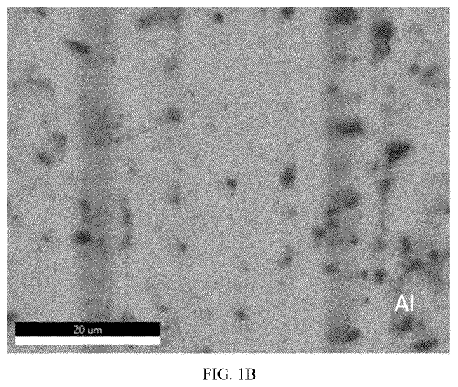

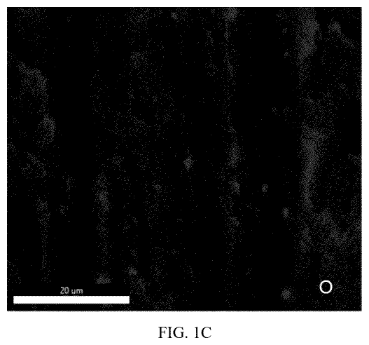

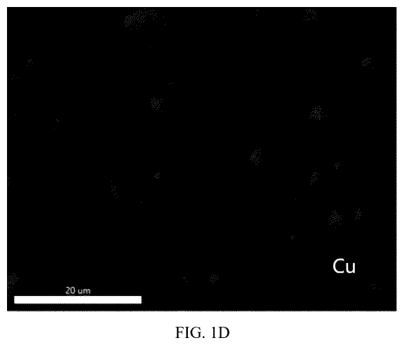

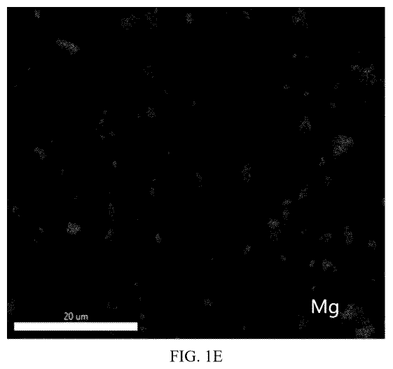

As shown in FIG. 1A-FIG. 4B, an integrated metal hydrogen-oxygen fuel cell system based on aluminum-lithium alloy is provided in this embodiment, which is a combined power supply system formed by coupling a metal-air cell 1 and a hydrogen-oxygen fuel cell 2, where the metal-air cell 1 includes a metal-air cell positive electrode 3, an electrolyte cavity 4, a negative electrode tab 5, an air cell air outlet 6 and an aluminum-lithium alloy negative electrode; the metal-air cell positive electrode 3 is connected with the electrolyte cavity 4 and is responsible for reacting with oxygen in the air, generating current and supporting continuous reaction of a cell; the electrolyte cavity 4 is connected with the negative electrode tab 5, and electrolyte in the electrolyte cavity 4 reacts with the aluminum-lithium alloy negative electrode 7 and outputs current through the negative electrode tab 5; the air cell air outlet 6 is arranged at a top of the metal-air cell 1 and is used for discharging hydrogen generated by a side reaction of the aluminum-lithium alloy negative electrode 7 and conveying the hydrogen to the hydrogen-oxygen fuel cell 2 through a gas pipe.

By regulating and controlling the element and morphology of the metal negative electrode in the air cell, with the increase of lithium in aluminum-lithium alloy, the electrochemical activity of the metal-air cell 1 increases, and the uniform corrosion in the aluminum-lithium alloy is capable of exposing the corrosion sites and providing a stable hydrogen source. The integrated metal hydrogen-oxygen fuel cell system structure obviously improves the energy utilization rate of the cell.

In this embodiment, the aluminum-lithium alloy negative electrode 7 is an alloy including four metal elements: Al, Mg, Cu and Li.

In this embodiment, the metal-air cell positive electrode 3 is formed by sequentially stacking and pressing the waterproof breathable membrane, the nickel mesh, the waterproof breathable membrane and the catalytic membrane; the waterproof breathable membrane is formed by mixing and pressing PTFE and carbon black materials; where a content of PTFE is 30-50 wt %, and a thickness of the waterproof breathable membrane is 0.30 mm.

In this embodiment, when preparing the metal-air cell positive electrode 3, a membrane electrode with a thickness of 0.56 mm is obtained by stacking and rolling in an order of a waterproof breathable membrane, a nickel mesh, the waterproof breathable membrane and a catalytic membrane, and the membrane electrode is sintered at 300° C. in a muffle furnace for 1 hour to obtain a complete air positive electrode.

In this embodiment, the catalytic membrane is formed by mixing and pressing the PTFE, conductive carbon, activated carbon and manganese dioxide in proportion, where a content of the PTFE is 10-15 wt %, contents of the conductive carbon, the activated carbon and the manganese dioxide are each 20-30 wt % respectively, and a thickness of the nickel mesh is 0.3 mm.

In this embodiment, the hydrogen-oxygen fuel cell 2 includes an anode plate 8 and a cathode plate 9; the hydrogen-oxygen fuel cell 2 is internally provided with a membrane electrode of the hydrogen-oxygen fuel cell 2; a hydrogen-oxygen fuel cell tab 12 is arranged above the anode plate 8; an anode part of the anode plate 8 is provided with an anode hydrogen inlet 10 which is communicated with an air outlet of the metal-air cell 1 and used for introducing hydrogen generated by the metal-air cell 1 into an anode of the hydrogen-oxygen fuel cell 2 for reaction.

In this embodiment, the opposite sides of the anode plate 8 and the cathode plate 9 are coated with an anode catalyst and a cathode catalyst respectively; the catalyst loading of an anode catalytic layer and a cathode catalytic layer is 0.5 mg/cm² of Pt/C for the anode and 0.25 mg/cm² of Pt/C for a cathode, respectively.

In this embodiment, a proton exchange membrane is arranged inside the cell membrane electrode 11, and a titanium mesh is arranged on the other side of the anode plate 8 of the anode catalytic layer, and the area of the titanium mesh electrode is 16 cm².

In this embodiment, the circuits of the metal-air cell 1 and the hydrogen-oxygen fuel cell 2 are connected in series, parallel or series-parallel connection.

### Embodiment 1

The negative electrode material is 2195 aluminum-lithium alloy, and its surface defects are uniform, which improves the electrochemical activity and energy utilization rate of the system. During the reaction of the metal-air cell 1, the aluminum-lithium alloy negative electrode 7 comes into contact with the electrolyte, and an oxidation reaction occurs to generate electrons and hydrogen. The generated hydrogen serves as a fuel source for the hydrogen-oxygen fuel cell 2. The negative electrode area is 30 cm², which ensures sufficient reaction surface area to maintain stable current output.

The positive electrode includes a waterproof breathable layer, a current collector nickel mesh and a catalytic layer. The catalytic layer includes manganese dioxide catalyst, PTFE binder, conductive carbon and activated carbon. After these materials are mixed, they are roughly pressed and finely pressed on a rolling machine to form a catalytic membrane with a thickness of 0.35 mm, in which the content of PTFE is 10 wt %, and the contents of conductive carbon, activated carbon and manganese dioxide are each 33.3 wt %.

The waterproof breathable layer is made of 30%PTFE and 70% carbon black, with a thickness of 0.30 mm, which ensures the air to enter the positive electrode smoothly and prevents the electrolyte from leaking. The current collector adopts 0.3 mm of thick nickel mesh, which is used to support the positive electrode structure and ensure the efficient conduction of electrons.

The waterproof breathable membrane, nickel mesh, waterproof breathable membrane and catalytic membrane are stacked in sequence and pressed by a rolling machine to obtain a membrane electrode with a total thickness of 0.56 mm. After the assembly, the membrane electrode is sintered in a muffle furnace at 300° C. for 1 hour to ensure the stability of the electrode structure and improve the conductivity and catalytic efficiency. The prepared membrane electrode is used for the positive electrode part of the metal-air cell 1. The electrolyte cavity 4 is filled with 100 mL of 4M KOH solution, which supports the negative electrode oxidation reaction, participates in the side reaction to generate hydrogen, and ensures the efficient operation of the cell.

Hydrogen generated by the aluminum-lithium alloy negative electrode 7 is discharged through the air cell air outlet 6 and delivered to the anode hydrogen inlet 10 of the hydrogen-oxygen fuel cell 2 through a gas path. Hydrogen-oxygen fuel cell 2 adopts PEMFC structure of the proton exchange membrane fuel cell, and Nafion212 is used as electrolyte membrane. 60% Pt/C catalyst is used for anode and cathode, and the loading is 0.5 mg/cm² and 0.25 mg/cm² respectively. Hydrogen is decomposed into electrons and protons at the anode, and the protons migrate to the cathode through the proton exchange membrane, and combine with oxygen to generate water. The electrons are transmitted through an external circuit and form a current, which is output by the hydrogen-oxygen fuel cell tab 12. The titanium mesh current collector of the anode is used to collect electrons and transmit them to the circuit to ensure the stable operation of the system.

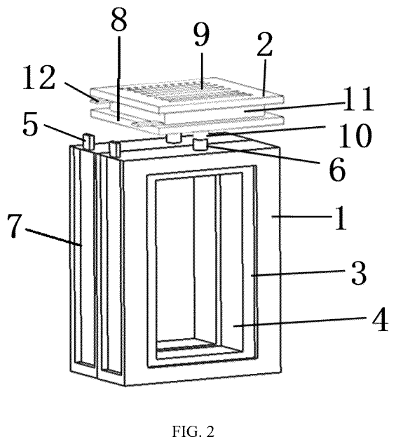

The hydrogen channel in the anode chamber of the hydrogen-oxygen fuel cell 2 is communicated with the air outlet at the top of the aluminum-lithium air cell. As shown in FIG. 2, the anode of the hydrogen-oxygen fuel cell 2 is vertically located right above the aluminum-lithium air cell. The double hydrogen inlet of the hydrogen-oxygen fuel cell 2 is communicated with the aluminum-lithium air cell, so that all hydrogen generated by the aluminum-lithium air cell is capable of flowing into the hydrogen-oxygen fuel cell 2; the double inlet ensures the uniform coverage of hydrogen at the anode of the hydrogen-oxygen fuel cell 2, thereby improving the discharge stability of the hydrogen-oxygen fuel cell 2; the unreacted hydrogen returns to the hydrogen-oxygen fuel cell 2 after circulation, thereby improving the utilization rate of hydrogen in the fuel cell system and avoiding the waste of resources. In the integrated aluminum-lithium air cell/hydrogen-oxygen fuel cell system structure, the tabs of the two modules are on the same side, which is easy to connect the cell circuits.

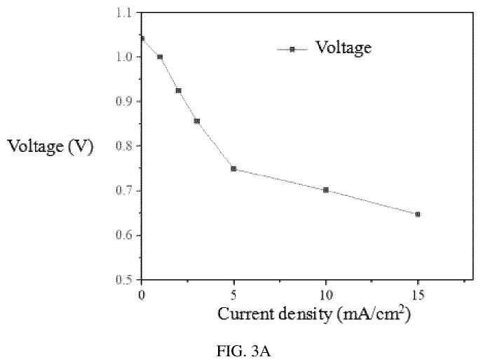

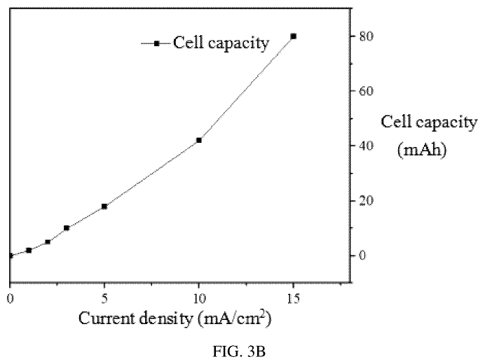

The aluminum-lithium air cell module and the hydrogen-oxygen fuel cell 2 in Embodiment 1 are tested for constant current discharge. The aluminum-lithium-air cell operates under the condition of constant current discharge of 5 mA/cm, which maintains a stable power output. Hydrogen-oxygen fuel cell 2 is tested in the constant current discharge range of 0-15 mA/cm², showing good electrochemical reaction performance. The specific discharge curve is shown in FIG. 3A-FIG. 3B.

As can be seen from FIG. 3A-FIG. 3B, under the above test conditions, the average discharge voltage of aluminum-lithium air cell is 1.53 V, which is equivalent to the performance of other commercial aluminum alloy air cells in the market, but the advantages of this system are higher efficiency and more stable performance. At the same time, the average discharge voltage of hydrogen-oxygen fuel cell 2 is 0.7 V in the range of 0-15 mA/cm², and the discharge curve is still stable even under different current densities, which shows that the catalytic layer and proton exchange membrane structure of the cell ensure long-term stable electric energy output. The test shows that the hydrogen absorption rate of the system is as high as 74%. This means that the hydrogen generated by the negative electrode side reaction of the aluminum-lithium-air cell is efficiently utilized by the hydrogen-oxygen fuel cell 2, thus reducing the waste of hydrogen. The traditional metal-air cell 1 often loses energy due to the side reaction of hydrogen evolution, and the system realizes the effective absorption and recycling of hydrogen by recovering hydrogen and using it in the hydrogen-oxygen fuel cell 2 to generate electricity.

Specifically, the coupling structure of the integrated aluminum-lithium air cell and hydrogen-oxygen fuel cell system not only improves the overall energy utilization rate of the system, but also improves the utilization efficiency of the metal negative electrode. The design of this dual-cell module promotes the full utilization of the side reaction products of aluminum-lithium air cell and avoid the waste of resources in traditional cells. Meanwhile, the stability of the system and the stationarity of the output voltage also show that the system is suitable for long-term running scenes.

Further, it can be seen from FIG. 3A-FIG. 3B that the average discharge voltage of the aluminum-lithium air cell is 1.5 v when the constant discharge current is 5 mA/cm². The constant current discharge current of the hydrogen-oxygen fuel cell 2 is 0-15 mA/cm². As can be seen from the figures, under the above test conditions, the oxygen fuel cell has an average discharge voltage of 0.7 v under the constant current discharge of 0-15 mA/cm², with excellent discharge performance and high stability. Hydrogen absorption reaches 74%.

### Embodiment 2

The area of the lithium aluminum negative electrode in Embodiment 2 is 110 cm², and the area of the lithium aluminum negative electrode in Embodiment 2 is greatly increased from 30 cm² to 110 cm². This means that a larger surface area will improve the reaction efficiency of the electrode and the overall power output of the cell.

In Embodiment 2, the PTFE content of the catalytic layer is increased to 15 wt %, and the contents of conductive carbon, activated carbon and manganese dioxide are each 28.3 wt %. The amount of the electrolyte in Embodiment 2 is increased to 300 ml to match the larger electrode area and ensure the efficiency and stability of the electrolytic reaction.

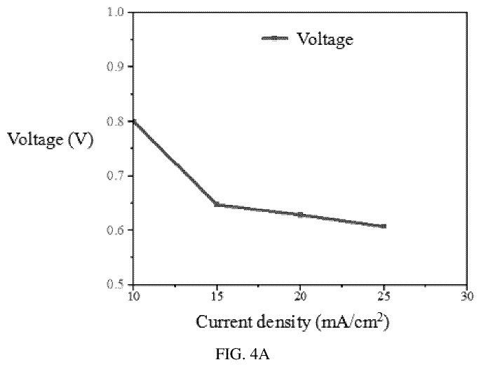

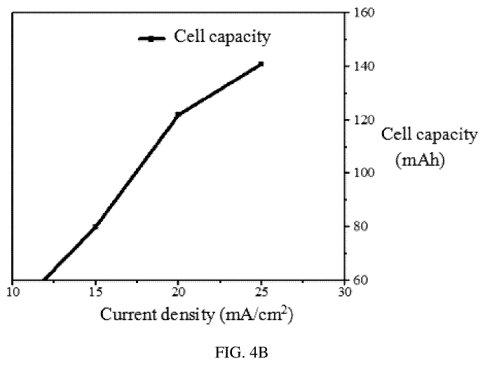

During the testing process in the Embodiment 2, the aluminum-lithium air cell module and the hydrogen-oxygen fuel cell 2 are tested by the constant current discharge to verify the performance under the condition of high current density. The aluminum-lithium-air cell operates at a constant current of 5 mA/cm², and maintains a stable voltage output. On the other hand, the hydrogen-oxygen fuel cell 2 is tested for the constant current discharge in a higher range of 15-25 mA/cm², and the specific performance data are shown in FIG. 4A-FIG. 4B. The test results show the excellent performance of the system under different current densities, and prove the stability under high load operation. Under the above test conditions, the average discharge voltage of aluminum-lithium air cell is 1.53 V, which is consistent with the performance of other commercial aluminum alloy air cells in the market. However, the system shows stronger stability and performance optimization ability at high current density. Hydrogen-oxygen fuel cell 2 has a constant current discharge range of 15-25 mA/cm², and the average discharge voltage is maintained at 0.6 V. Even under the condition of high current density, the voltage attenuation of the system is still very small, which shows that the catalytic layer and the proton exchange membrane have excellent stability and durability.

The hydrogen absorption rate of the system is as high as 86%, which is much higher than that of the traditional fuel cell system. This means that most of the hydrogen generated by the negative electrode of the aluminum-lithium air cell is efficiently recovered and used in the power generation process of the hydrogen-oxygen fuel cell 2. This design solves the problem of resource waste caused by the side reaction of hydrogen evolution in traditional metal-air cell 1, and realizes the effective utilization and cyclic regeneration of hydrogen. Hydrogen-oxygen fuel cell 2 still maintains efficient power generation under different load conditions, further improving the energy utilization rate of the system.

Specifically, with the increase of the electrode area of the metal-air cell 1, the system is capable of generating more hydrogen, thus meeting the operation requirements of the hydrogen-oxygen fuel cell 2 under the condition of high current density. This modular combined power supply system realizes higher power output by integrating aluminum-lithium air cell and hydrogen-oxygen fuel cell 2, which is suitable for high-power application scenarios that need long-term stable power supply. The design can meet the application requirements of high demand scenarios such as emergency power supply and standby power system, and reduce resource waste while improving energy efficiency.

More specifically, in FIG. 4A-FIG. 4B, the constant current discharge current of the aluminum-lithium air cell is 5 mA/cm², and the constant current discharge current of the hydrogen-oxygen fuel cell 2 is 15-25 mA/cm².

The present disclosure is not limited to the above-mentioned embodiments, and anyone should know that the structural changes made under the inspiration of the present disclosure, which have the same or similar technical scheme as the present disclosure, fall within the protection scope of the present disclosure. The technologies, shapes and structural parts not described in detail in the present disclosure are all well-known technologies.

What is claimed is:

1. An integrated metal hydrogen-oxygen fuel cell system based on aluminum-lithium alloy, which is a combined power supply system formed by coupling a metal-air cell and a hydrogen-oxygen fuel cell, wherein the metal-air cell comprises a metal-air cell positive electrode, an electrolyte cavity, a negative electrode tab, an air cell air outlet and an aluminum-lithium alloy negative electrode; the metal-air cell positive electrode is connected with the electrolyte cavity and is responsible for reacting with oxygen in the air, generating current and supporting continuous reaction of a cell; the electrolyte cavity is connected with the negative electrode tab, and electrolyte in the electrolyte cavity reacts with the aluminum-lithium alloy negative electrode and outputs current through the negative electrode tab; the air cell air outlet is arranged at a top of the metal-air cell and is used for discharging hydrogen generated by a side reaction of the aluminum-lithium alloy negative electrode and conveying the hydrogen to the hydrogen-oxygen fuel cell through a gas pipe;
the aluminum-lithium alloy negative electrode is an alloy comprising four metal elements: Al, Mg, Cu and Li;
when preparing the metal-air cell positive electrode, a membrane electrode with a thickness of 0.56 mm is obtained by stacking and rolling in an order of a waterproof breathable membrane, a nickel mesh, the waterproof breathable membrane and a catalytic membrane, and the membrane electrode is sintered at 300° C. in a muffle furnace for 1 hour to obtain a complete air positive electrode.

2. The integrated metal hydrogen-oxygen fuel cell system based on aluminum-lithium alloy according to claim 1, wherein the metal-air cell positive electrode is formed by sequentially stacking and pressing the waterproof breathable membrane, the nickel mesh, the waterproof breathable membrane and the catalytic membrane; the waterproof breathable membrane is formed by mixing and pressing PTFE and carbon black materials; wherein a content of PTFE is 30-50 wt %, and a thickness of the waterproof breathable membrane is 0.30 mm.

3. The integrated metal hydrogen-oxygen fuel cell system based on aluminum-lithium alloy according to claim 2, wherein the catalytic membrane is formed by mixing and pressing the PTFE, conductive carbon, activated carbon and manganese dioxide in proportion, wherein a content of the PTFE is 10-15 wt %, contents of the conductive carbon, the activated carbon and the manganese dioxide are each 20-30 wt % respectively, and a thickness of the nickel mesh is 0.3 mm.

4. The integrated metal hydrogen-oxygen fuel cell system based on aluminum-lithium alloy according to claim 3, wherein the hydrogen-oxygen fuel cell comprises an anode plate and a cathode plate; the hydrogen-oxygen fuel cell is internally provided with a membrane electrode of the hydrogen-oxygen fuel cell; a hydrogen-oxygen fuel cell tab is arranged above the anode plate; an anode part of the anode plate is provided with an anode hydrogen inlet which is communicated with an air outlet of the metal-air cell and used for introducing hydrogen generated by the metal-air cell into an anode of the hydrogen-oxygen fuel cell for reaction.

5. The integrated metal hydrogen-oxygen fuel cell system based on aluminum-lithium alloy according to claim 4, wherein opposite sides of the anode plate and the cathode plate are coated with an anode catalyst and a cathode catalyst respectively; the catalyst loading of an anode catalytic layer and a cathode catalytic layer is 0.5 mg/cm² of Pt/C for the anode and 0.25 mg/cm² of Pt/C for a cathode, respectively.

6. The integrated metal hydrogen-oxygen fuel cell system based on aluminum-lithium alloy according to claim 5, wherein a proton exchange membrane is arranged inside a cell membrane electrode; one side of the anode plate is provided with the anode catalytic layer, and an other side of the anode plate is provided with a titanium mesh.

7. The integrated metal hydrogen-oxygen fuel cell system based on aluminum-lithium alloy according to claim 6, wherein circuits of the metal-air cell and the hydrogen-oxygen fuel cell are connected in series, parallel or series-parallel connection.
